(19) United States
(12) Patent Application Publication
(10) Pub. No.: US 2016/0378419 A1
(43) Pub. Date: Dec. 29, 2016

(54) VISUAL OR USER INTERFACEABLE KIOSK OR INFORMATION APPARATUS

(71) Applicant: Lennar Pacific Properties Management, Inc., Miami, FL (US)

(72) Inventors: John Abraham, Irvine, CA (US); John Greer, San Diego, CA (US); Kevin McHugh, Chapel Hill, NC (US)

(21) Appl. No.: 15/194,243

(22) Filed: Jun. 27, 2016

Related U.S. Application Data
(60) Provisional application No. 62/184,644, filed on Jun. 25, 2015.
(60) Provisional application No. 62/184,677, filed on Jun. 25, 2015.

(51) Int. Cl. G06F 3/14; G06Q 50/16; G09G 5/14; G06Q 30/06; G06F 3/16; G06F 3/0481

(52) U.S. Cl. CPC G06F 3/1423; G06F 3/167; G06F 3/0481; G09G 5/14; G06Q 30/0625; G06Q 50/16; G09G 2360/06

(57) ABSTRACT

An apparatus (e.g., kiosk, information wall, stand, etc.) for displaying an executed software application. The apparatus may be used to display search results regarding real estate properties and allow a user to interface therewith to input desired criteria. The apparatus may include multiple displays (e.g., synchronized) or a single display, multiple users that may simultaneously interface with the apparatus (e.g., either via a single user per display and/or multiple users using a single display), and/or may include sound (e.g., directional sound). The apparatus may be connected (e.g., hard-wired and/or wireless connections) with one or more computers that execute, receive input, and/or output images or other data to the kiosk. High resolution and/or large dimension displays may allow for placement of the apparatus in leasing offices or other company-owned locations for attracting customers and allowing potential customers to interface therewith in place of or in cooperation with employees of the company.

### CROSS REFERENCE TO RELATED APPLICATIONS

This application claims the benefit of U.S. Provisional Patent Application Ser. No. 62/184,677, filed on Jun. 25, 2015, entitled “USER INTERFACEABLE KIOSK OR INFORMATION APPARATUS,” which is hereby incorporated by reference in its entirety. This application also claims the benefit of U.S. Provisional Patent Application Ser. No. 62/184,644, filed on Jun. 25, 2015, entitled “REAL ESTATE SEARCH METHOD AND APPARATUS,” which is hereby incorporated by reference in its entirety.

### BACKGROUND

1. Field of the Invention

The present invention relates to an apparatus, system, and/or method for allowing a user to interface therewith and/or obtain information. More particularly, the present invention relates to a high-definition kiosk or information apparatus that is interfaceable or viewable by a user for aesthetic purposes and/or for obtaining user-desired information, such as real-estate search results based on input criteria, or other visual structures with or without user-input criteria.

2. Description of the Related Art

The home search or real estate market is a large business both in the United States and Worldwide, linking potential customers of a large variety of real estate properties (e.g., single family homes, apartment homes, condominiums, land, business leases, etc.) with a vast array of information about such properties. Typically, a potential customer has one or more criteria of particular interest when shopping for a new residence (e.g., price, geographic location, square footage, etc.) and can either communicate with a real estate agent and/or browse different real estate management or agent webpages online in an effort to locate a desirable home. Unfortunately, this process is generally time consuming and inefficient, as a user may have to hop around to different property web pages or talk to a number of different property agents to determine availability. For example, if a potential customer is interested in units at a first apartment complex and a second apartment complex, the user may be required to browse a different webpage for each and/or talk to an agent at each respective complex in order to determine what units are available and their characteristics. This may occur even when the two apartment complexes are commonly owned by one company. In addition, the process of real estate shopping can be daunting, stressful, and/or off-putting to consumers.

Thus, there is a need for an improved apparatus, system, and/or method that is intuitive for a user to interface with and/or an apparatus, system, and/or method that is an attractive showpiece for alluring in potential customers. Ideally, the apparatus, system, and/or method would incorporate technology so that potential consumers are drawn to its interesting, fun-looking, and/or futuristic demeanor and/or be encouraged to shop or obtain information through its use.

### SUMMARY

The present invention is related to an apparatus or system that allows for customer interaction in order to obtain information and/or enjoyment. One embodiment or use for such an apparatus or system would be as a kiosk or information system that allows potential customers to shop for real estate properties. Another embodiment or use for such an apparatus or system would be as a large display in a business, such as a motivational wall, that attracts new customers thereto or is pleasing to the eye for existing customers.

In one embodiment, an apparatus for providing visual stimulation to a user may include a first display screen configured to receive first input, at least one lighting cell configured to illuminate through at least one or the plurality of tiled materials based upon interaction by the user, a plurality of tiled materials disposed adjacent to the first display screen, and a base disposed long an edge of at least one of the plurality of tiled materials configured to dissipate heat from an area adjacent to the first display screen to a second area.

In another embodiment, an apparatus for providing visual stimulation to a user may include a first display screen configured to receive first input, a second display screen positioned adjacent to the first display screen and configured to receive second input, a first processor connected with the first display screen, a second processor connected with the second display screen, a memory connected with the first processor, and a plurality of tiled materials disposed adjacent to the first display screen and the second display screen, wherein the first processor is configured to determine data to be displayed on the first display screen based upon the first input received via the first display screen and wherein the second processor is configured to determine second data to be displayed on the second display screen based upon the second input received via the second display screen.

In still another embodiment, a method for receiving and responding to user input may include providing a first display configured to receive a first input, providing a second display configured to receive a second input, providing a first directional audio component configured to emit sound corresponding to the first display, providing a second directional audio component configured to emit sound corresponding to the second display, determining first visual data to be displayed on the first display based upon the first input received via the first display, determining second visual data to be displayed on the second display based upon the second input received via the second display, determining first audible data to be emitted by the first directional audio component, determining second audible data to be emitted by the second directional audio component, and communicating the first visual data to the first display, the second visual data to the second display, the first audible data to the first directional audio component, and the second audible data to the second directional audio component.

### BRIEF DESCRIPTION OF THE DRAWINGS

The features, objects, and advantages of the present invention will become more apparent from the detailed description set forth below when taken in conjunction with the drawings, wherein:

FIG. 1 shows an apparatus or system incorporating a single display and lighting cells as part of a kiosk or wall according to one embodiment of the present invention;

FIG. 2 shows an apparatus or system incorporating a dual display as part of a kiosk or wall according to one embodiment of the present invention;

FIG. 3 shows an apparatus or system incorporating a dual display and half-size lighting cells as part of a kiosk or wall according to one embodiment of the present invention;

FIG. 4A shows an apparatus or system incorporating a dual display and full-size lighting cells as part of a kiosk or wall according to one embodiment of the present invention;

FIG. 4B-1 shows the dual display and full size lighting cells of FIG. 4A under a first stage of construction according to one embodiment of the present invention;

FIG. 4B-2 shows the dual display and full size lighting cells of FIG. 4A under a second stage of construction according to one embodiment of the present invention;

FIG. 4B-3 shows the dual display and full size lighting cells of FIG. 4A under a third stage of construction according to one embodiment of the present invention;

FIG. 5A shows an apparatus or system incorporating four displays as part of a kiosk or wall according to one embodiment of the present invention;

FIG. 5B shows an apparatus or system incorporating nine displays as part of a kiosk or wall according to one embodiment of the present invention;

FIG. 6 shows an apparatus or system incorporating directional sound technology as part of a kiosk or wall according to one embodiment of the present invention;

FIG. 7 shows a block diagram of an apparatus or system incorporating multiple display and sound technologies as part of a kiosk or wall according to one embodiment of the present invention; and

FIG. 8 shows a block diagram of a system implementing a software application configured to be used as part of a kiosk or wall according to one embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

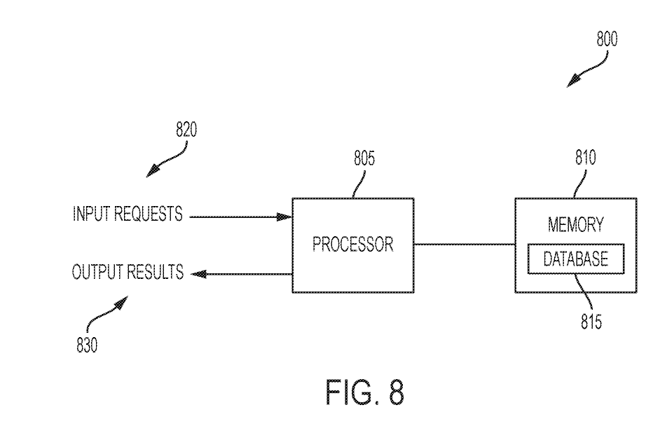

Initially turning to FIG. 8, a block diagram of a system 800 is shown that may implement a software application, such as a home or real estate search and/or information provision software application, for display upon one or more displays. In one embodiment, the software application may be configured to be executed and/or displayed as part of a large, user-interfaceable kiosk or information wall and may include features that are the same as or similar to those discussed throughout. The system 800 includes a processor 805 connected with a memory 810, the memory 810 configured to store data. The processor 805 may include multiple processors (e.g., local or remote to one another) one or more of which are configured to interface or otherwise communicate with the memory 810, for example, via electrical signals propagated along a conductive trace or wire or via network connections (e.g., Internet or intranet connections). In an alternative embodiment, the processor 805 may interface with the memory 810 via a wireless connection. In one embodiment, the memory 810 may include a database 815, a plurality of data or entries capable of being stored in the database 815 (or other portions) of the memory 810. For example, as discussed in greater detail herein, the memory 810 and/or the database 815 may store information about real estate properties that may be accessed and/or retrieved and/or sent to a user based upon user requests and/or criteria. Additional and/or alternative data may be stored in the database 815 and/or no database may be needed as part of the memory 810 in alternative embodiments.

As discussed in greater detail herein, the processor 805 may be tasked with executing software or other logical instructions in order for the software application to function as desired. Input requests 820 (e.g., received touches from a user upon a monitor or touchscreen) may be received by the processor 805 (e.g., via signals transmitted from a user at a remote system or device, such as a kiosk, wall, and/or other handheld device like a smartphone or tablet, to the processor 805 via a network or Internet connection). In an alternative embodiment, the input requests 820 may be received by the processor via a user input device that is not at a geographically remote location (e.g., via a connected keyboard, mouse, local touchscreen, etc. at a local computer terminal). After performing tasks or instructions based upon the user input requests 820, for example, looking up information or data stored in the memory 810, the processor 805 may output results 830 back to the user that are based upon the input requests 820. In still other embodiments, input requests 820 may not be needed and/or incorporated in the system 800 (e.g., for a system that is configured to display images, sounds, and/or other sensory output for one or more users, but not accept user input). In an alternative embodiment, any of a variety of systems capable of receiving input data, accessing stored data, processing software instructions, and/or transmitting output data may be utilized.

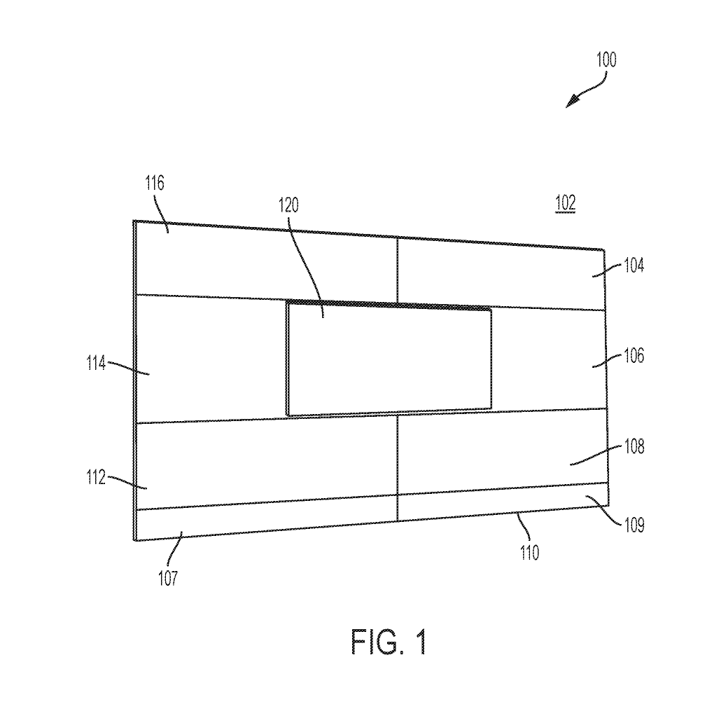

In FIG. 1, an apparatus or system 100 incorporating a single display and lighting cells as part of a kiosk or information wall is shown. For example, such an apparatus or system may be used for the purposes of permitting a user (or multiple users) to interface with software configured to help determine real estate or other property that may be desired for purchase or lease. The apparatus or system may be setup, for example, within a leasing office of a home manufacturer, real estate business, apartment, condo, or neighborhood development, etc. In an alternative embodiment, however, the apparatus or system 100 and/or some or all of its features may be used for a variety of purposes that would benefit from receiving user input and displaying information back to the user based upon that input. In still other embodiments, input from users may not be needed or desired and certain features of the system 100 may be used without user input or interfacing functionality.

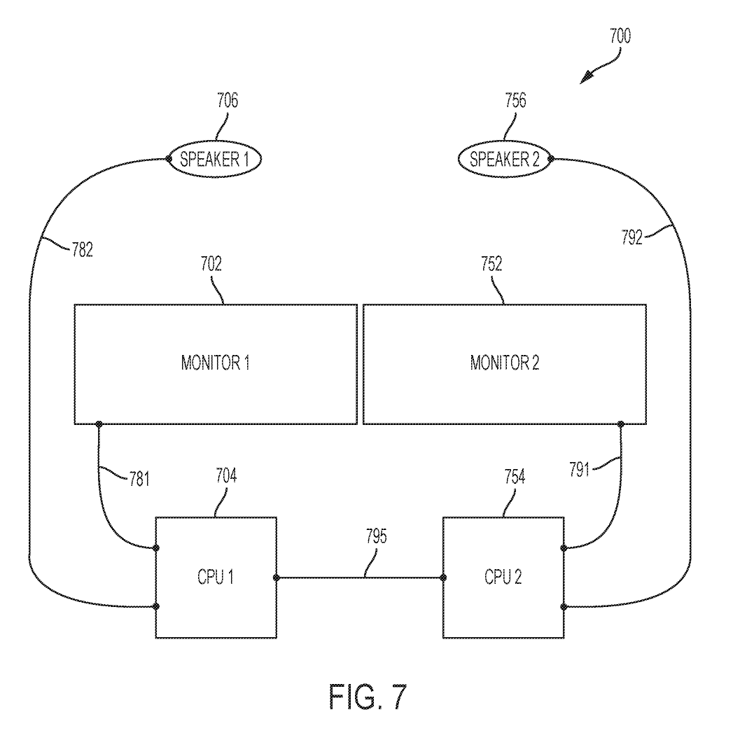

The apparatus or system 100 may be built into a kiosk, stand, or wall 102 such that it is maintained in an upright (e.g., vertical), or otherwise standing configuration such that a user can view and interface with its display face and/or other components. In an alternative embodiment, the apparatus or system 100 may be designed to be arranged in other orientations (e.g., built into a floor or ceiling). The apparatus or system 100 may include a display screen 120 (such as a television, monitor, or other display device) that can provide visual information to a user. In one preferred embodiment, the display screen 120 may be large in size (e.g., 84″ diagonal) and/or have a high resolution (e.g., 4K resolution—3840×2160). In addition, the display screen 120 may ideally be a touch screen (e.g., 32-point multi-touch) in order to accept user input. Connected computers and/or other programmable or executable machines may be connected with the displays to power and/or control their display, as discussed in greater detail herein, for example for FIG. 7.

In certain embodiments, the display screen 120 may be manufactured, covered, and/or coated with a protective material or substance (e.g., Corning Gorilla Glass) or other protective means in order to lessen the risk of damage through use, shipment, or setup. An ideal display screen 120 would be capable of being easily viewable in lit conditions (e.g., have a brightness of 500 nits or greater). Any of a variety of screens or monitors having a variety of characteristics may be used in alternative embodiments, however. In one embodiment, the total dimensions of the apparatus or system 100 may be fourteen feet, nine inches long and eight feet, ten inches high. In an alternative embodiment, any of a variety of other dimensions, shapes, sizes, and/or configurations may be utilized.

Surrounding the display screen 120 are a plurality of tiled material components (104, 106, 108, 107, 109, 112, 114, 116), such as glass. In one embodiment, the tiled material components (104, 106, 108, 107, 109, 112, 114, 116) may be capable of being colored (e.g., painted, stained, film-on-glass, etc.) or otherwise modified (e.g., textured, patterned, etc.) in any of a variety of different colors and/or manners. Different colors or manners may be used for different applications (e.g., to match a company or corporations colors or patterns). The display screen 120 and/or tiled material components (104, 106, 108, 107, 109, 112, 114, 116) may be surrounded or framed with a trim or finish (e.g., clear anodized aluminum or other metal, plastic, etc.), which may provide additional stability to the apparatus or system 100. As illustrated, the tiled material components (104, 106, 108, 107, 109, 112, 114, 116) may be placed or tiled such that they line up with one or more edges of the display screen 120 and/or with the center of one or more sides of the display screen 120.

On the left and right sides of the display screen 120 and behind the tiled material components 114 and 106 (and thus obscured from view in FIG. 1), one or more lighting cells (e.g., Sensacells) may be installed and configured to user interaction. For example, the lighting cells may be LEDs that are configured to respond to user input (e.g., via capacitive motion/proximity sensors) to change in color, brightness, or otherwise alter their display characteristics when a user interacts therewith. Thus, in one embodiment, a user may interact with the display screen 120 (e.g., via touch) and/or interact with one or more lighting cells located behind tiled material components 114 and 106. In an alternative embodiment, additional or alternative lighting elements (e.g., non-user-interfaceable lights) may be disposed behind and/or adjacent to any of the tiled material components (104, 106, 108, 107, 109, 112, 114, 116). In still another an alternative embodiment, no lighting cells or lights may be used and/or they may be included behind one or more other tiled material components adjacent to the display screen 120.

A base 110 extending along a bottom of the apparatus or system 100 may contain openings (e.g., perforated holes, slits, or other shape or element) such that airflow is permitted. Alternative embodiments may place a similar base or structure with similar functionality along additional and/or alternative sides of the apparatus or system 100. The base 110 may help, for example, by allowing air to flow behind the display screen 120 and/or one or more of the tiled material components (104, 106, 108, 107, 109, 112, 114, 116) to aid in the transfer of heat, for example, to the outside of the apparatus or system 100. In certain embodiments, fans or other facilitators of air movement or heat transfer may be used to additionally aid in heat transfer. In alternative embodiments that incorporate components having more extensive heat generation, alternative or additional heat management (e.g., water-cooling, heat exchangers, etc.) may be employed.

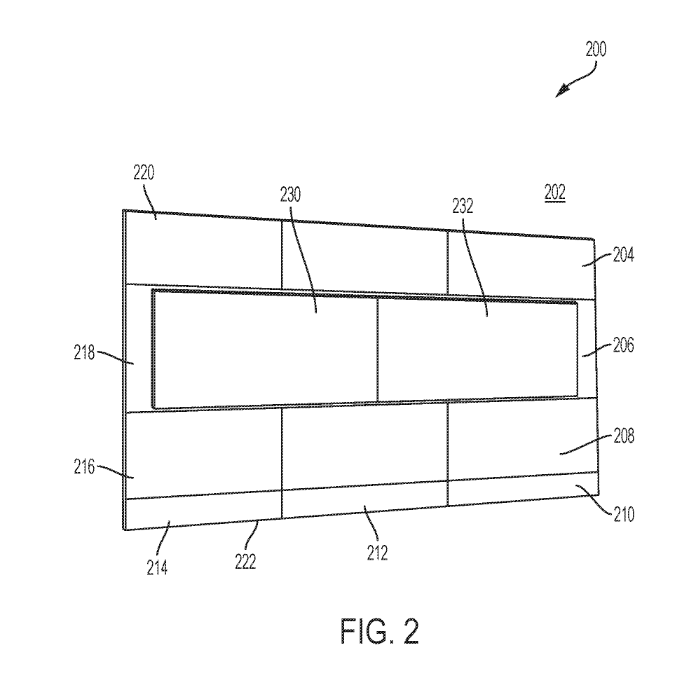

FIG. 2 shows an apparatus or system 200 incorporating a dual display as part of a kiosk or wall. The apparatus or system 200 may include features that are the same or similar to those previously discussed. For example, the apparatus or system 200 may include two display screens (230, 232), a plurality of tiled material components (204, 206, 208, 210, 212, 214, 216, 218, 220), and a base 222 for airflow and/or other heat management, the same as or similar to those previously discussed. In addition, the apparatus or system 200 may be constructed as part of a kiosk or wall 202 to help facilitate user interaction and/or user viewing, the same as or similar to those previously discussed. However, contrary to the embodiment illustrated in FIG. 1, as illustrated, the apparatus or system 200 utilizes the two display screens (230, 232) instead of one and may not include any additional lighting cell functionality. In certain embodiments, the two display screens (230, 232) may utilize only one display screen and/or may utilize more than two display screens. Each display screen (230, 232) may be driven by a separate and/or independent computer device, for example, as discussed in greater detail in FIG. 7.

In one preferred embodiment, one or both of the two display screens (230, 232) may be large in size (e.g., dual 84″ diagonal) and/or have a high resolution (e.g., 4K resolution—3840×2160) and have other features the same as or similar to those previously discussed. In one embodiment, the total dimensions of the apparatus or system 200 may be fourteen feet, three inches long and eight feet, ten inches high. In an alternative embodiment, any of a variety of other dimensions, shapes, sizes, and/or configurations may be utilized.

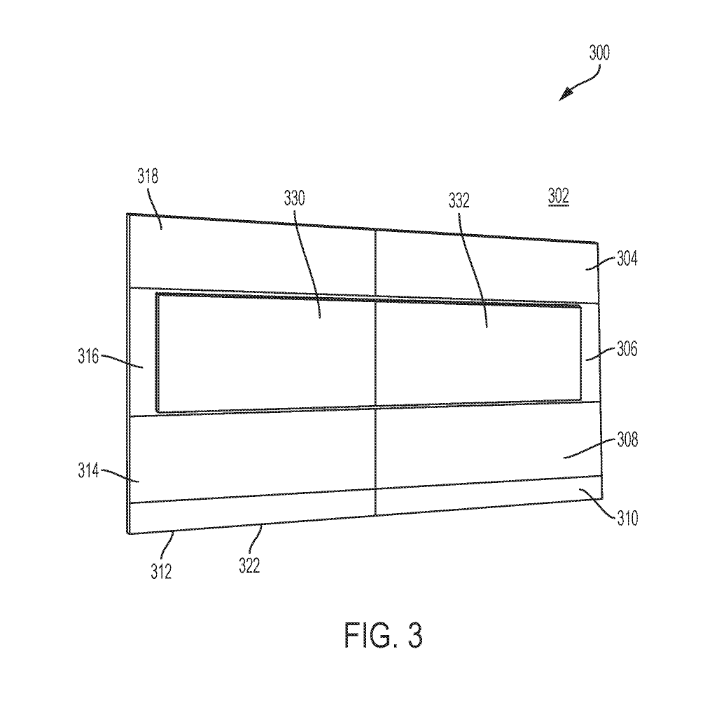

FIG. 3 shows an apparatus or system 300 incorporating a dual display as part of a kiosk or wall. The apparatus or system 300 may include features that are the same or similar to those previously discussed. For example, the apparatus or system 300 may include display screens (330, 332), a plurality of tiled material components (304, 306, 308, 310, 312, 314, 316, 318), and a base 322 for airflow or other heat management, the same as or similar to those previously discussed. In addition, the apparatus or system 300 may be constructed as part of a kiosk or wall 302 to help facilitate user interaction or user viewing, the same as or similar to those previously discussed. However, contrary to the embodiment illustrated in FIG. 2, as illustrated, the apparatus or system 300 may include additional lighting or lighting cell functionality (e.g., may have a lesser amount of lighting cells than previously shown in FIG. 1). For example, the lighting or lighting cells may be positioned behind tiled material components (306, 316) or, in an alternative embodiment, may be positioned behind or adjacent to any of a variety of the tiled material components (304, 306, 308, 310, 312, 314, 316, 318) and/or display screens (330, 332) as desired. In certain embodiments, the two display screens (330, 332) may instead utilize only one display screen and/or may utilize more than two display screens. Each display screen (330, 332) may be driven by a separate and/or independent computer device, for example, as discussed in greater detail in FIG. 7.

In one preferred embodiment, one or more of the display screens (330, 232) may be large in size (e.g., dual 84″ diagonal) and/or have a high resolution (e.g., 4K resolution—3840×2160) and have other features the same as or similar to those previously discussed. In one embodiment, the total dimensions of the apparatus or system 300 may be fifteen feet, six inches long and eight feet, ten inches high. In an alternative embodiment, any of a variety of other dimensions, shapes, sizes, and/or configurations may be utilized.

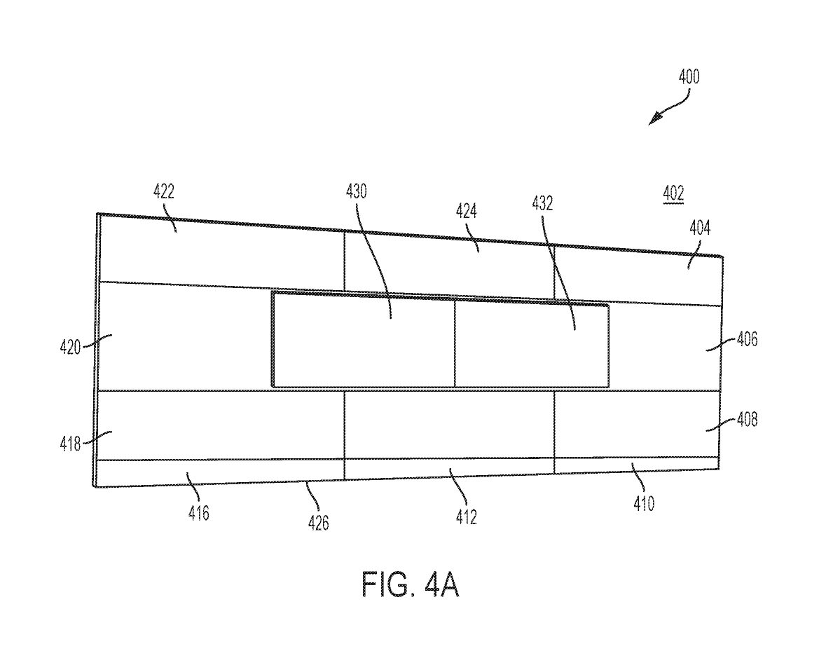

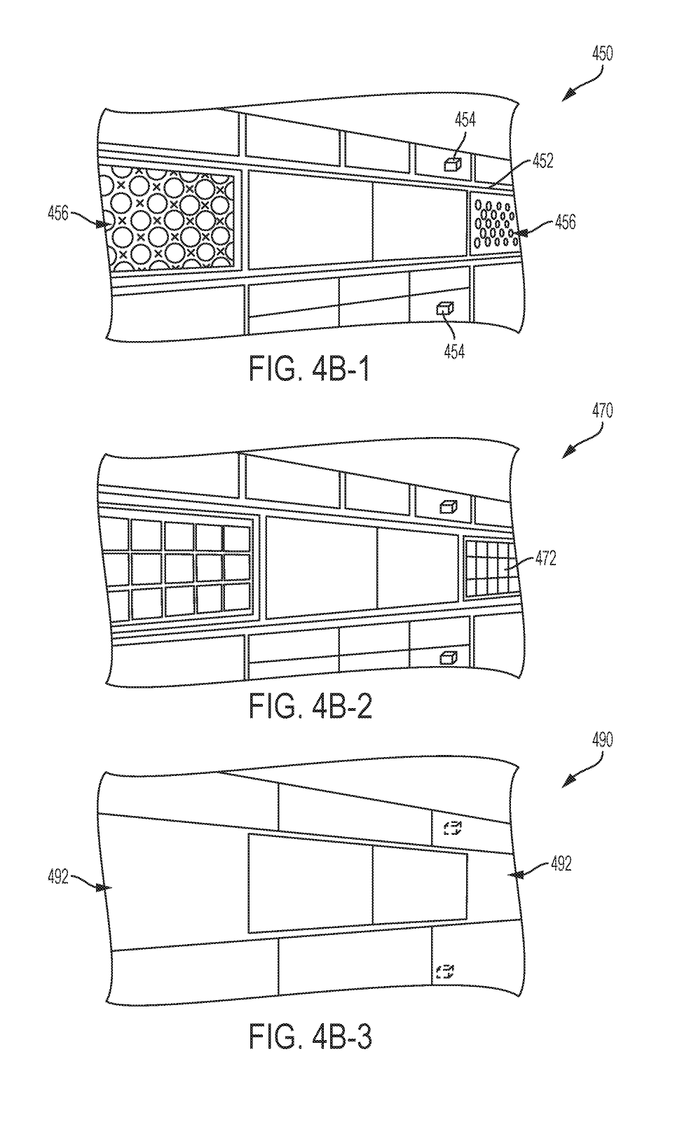

FIG. 4A shows an apparatus or system 400 incorporating a dual display and lighting cells as part of a kiosk or information wall. The apparatus or system 400 may include features that are the same or similar to those previously discussed. For example, the apparatus or system 400 may include display screens (430, 432), a plurality of tiled material components (404, 406, 408, 410, 412, 416, 418, 420, 422, 424), and a base 426 for airflow or other heat management, the same as or similar to those previously discussed. In addition, the apparatus or system 400 may be constructed as part of a kiosk or wall 402 to help facilitate user interaction or user viewing, the same as or similar to those previously discussed. However, contrary to the embodiment illustrated in FIG. 3, as illustrated, the apparatus or system 400 may include increased amounts of lighting or lighting cells. For example, the lighting or lighting cells may be positioned similarly behind tiled material components (406, 420) or, in an alternative embodiment, may be positioned behind or adjacent to any of a variety of the tiled material components (404, 406, 408, 410, 412, 416, 418, 420, 422, 424) and/or display screens (430, 432) as desired. In certain embodiments, the two display screens (430, 432) may utilize only one display screen and/or may utilize more than two display screens. Each display screen (430, 432) may be driven by a separate and/or independent computer device, for example, as discussed in greater detail in FIG. 7.

In one preferred embodiment, the display screens (430, 432) may be large in size (e.g., dual 84″ diagonal) and/or have a high resolution (e.g., 4K resolution—3840×2160) and have other features the same as or similar to those previously discussed. In one embodiment, the total dimensions of the apparatus or system 400 may be twenty three feet, seven inches long and eight feet, ten inches high. In an alternative embodiment, any of a variety of other dimensions, shapes, sizes, and/or configurations may be utilized.

Turning to the next three drawings, FIG. 4B-1 shows the dual display and lighting cell setup of FIG. 4A under a first stage of construction 450 in order to highlight aspects and/or placement of certain components of the apparatus or system 400 that might otherwise be obscured from view. With reference to FIG. 4A and FIG. 4B-1, as illustrated, the two display screens (430, 432) are mounted as part of a framing system 452 (e.g., metal, plastic, etc.). Areas adjacent to the display screens (430, 432) are illustrated with mounting hardware 456 provided for the mounting of lighting or lighting cells (e.g., see FIG. 4B-2). Electrical connections, power, and/or other wiring 454 for the display screens (430, 432) and/or other equipment are disposed adjacent to the screens (e.g., mounted to a wall, frame, etc.) such that they may be covered, or obscured by other components, such as one or more tiled materials (e.g., see FIG. 4B-3). FIG. 4B-2 shows the dual display and lighting or lighting cells of FIG. 4A under a second stage of construction 470 and demonstrates the inclusion and power-up of lighting cells 472 (e.g., via the mounting hardware 456 of FIG. 4B-1). In addition, as illustrated, tiled material components have been installed to cover the electrical wiring/connections 454 previously viewable in FIG. 4B-1. Finally, FIG. 4B-3 shows the dual display and lighting or lighting cells of FIG. 4A under a third stage of construction 490 and demonstrates additional tiled material components 492 (e.g., glass, for example, tinted or otherwise colored) disposed over the lighting cells 472. These components 492 may permit some or all of the illumination of the lighting cells 472 therethrough, but provide a more finished look to the kiosk or wall. As shown, one or more of the Electrical connections, power, and/or other wiring 454 may also be disposed behind one or more of tiled material components and/or otherwise covered or hidden by aspects of the apparatus (e.g., kiosk, stand, wall, etc.). In an alternative embodiment, any of a variety of construction designs and/or orientations may be utilized.

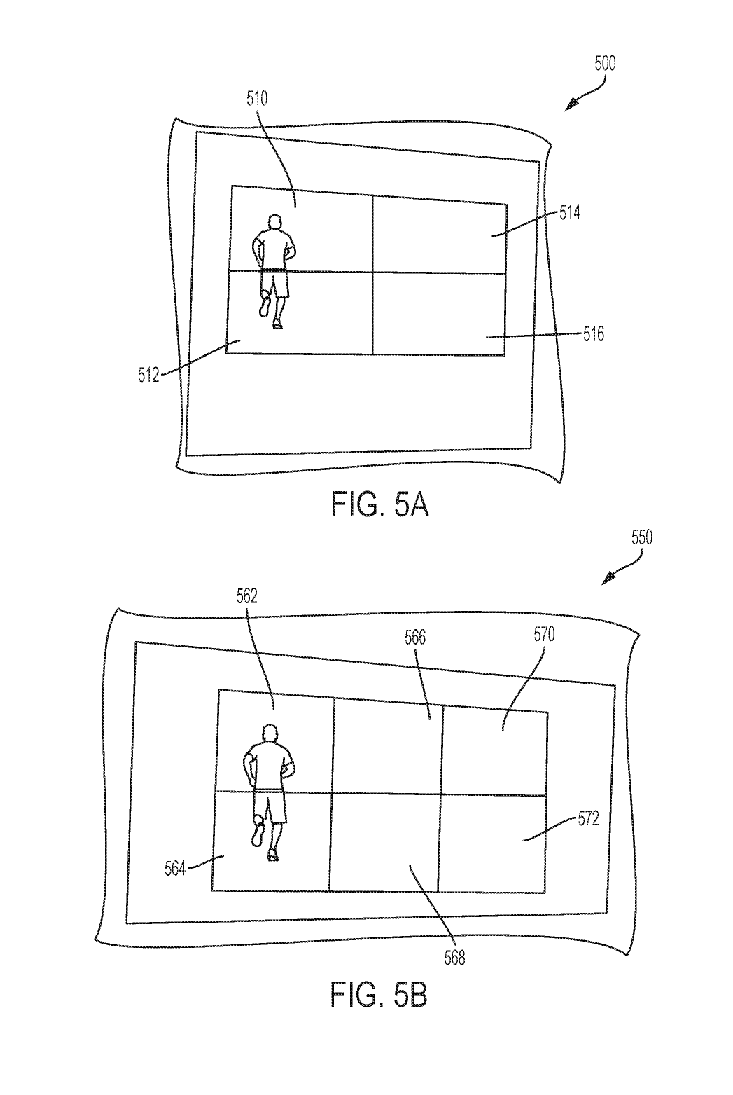

FIGS. 5A and 5B show apparatus or systems (500, 550, respectively) that incorporate a plurality of display screens as part of a kiosk, stand, or wall. Both the apparatus or systems (500, 550) may include features that are the same or similar to those previously discussed. For example, the apparatus or system 500 may include display screens (510, 512, 514, 516), a plurality of surrounding tiled material components and a base for airflow or heat management, the same as or similar to those previously discussed. In an alternative embodiment, surrounding material may not be tiled (e.g., drywall, may be a single frame or material with an opening in the center for the one or more display screens (510, 512, 514, 516), etc.) and/or no surrounding material components and/or base may be utilized. The apparatus or system 500 includes four display screens.

These display screens (510, 512, 514, 516) may form a screen that is, in one embodiment, 110 inches diagonal and have a resolution of 1080p (1920×1080 pixels) with a brightness of 800 nits, however, other characteristics or properties may be used in alternative embodiments. Similarly, the apparatus or system 550 of FIG. 5B may include display screens (562, 564, 566, 568, 570, 572), a plurality of surrounding tiled (e.g., or non-tiled) material components and a base for airflow, the same as or similar to those previously discussed. These display screens (562, 564, 566, 568, 570, 572) may form a screen that is, in one embodiment, 165 inches diagonal and have a resolution of 1080p (1920×1080 pixels) with a brightness of 800 nits, however, other characteristics or properties may be used in alternative embodiments.

In certain embodiments, the display screens (510, 512, 514, 516) and/or display screens (562, 564, 566, 568, 570, 572) may be user-interfaceable (e.g., touch screens) or may not accept user input and instead just display images and/or videos (e.g., for use as a motivational wall or other multi-monitor display kiosk or wall, such as for showing motivational videos like at fitness facility, etc.). Although the embodiments in FIGS. 5A and 5B illustrate four screens or six screens, in an alternative embodiment, any of a number of display screens may be used in any of a variety of orientations or configurations. Lighting and/or lighting cells and/or other visual or interfaceable elements may be utilized in certain embodiments with the display screens (510, 512, 514, 516) and/or display screens (562, 564, 566, 568, 570, 572). In still other embodiments, other forms of stimulation may be incorporated (e.g., audible, tactile, etc.) into either a user-interfaceable setup or a non-interfaceable setup.

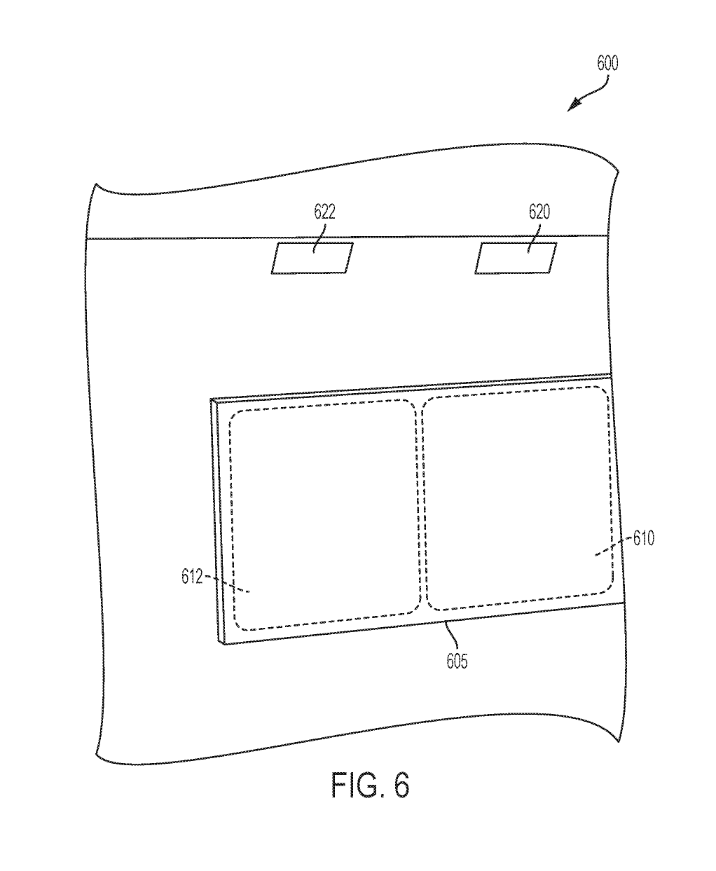

FIG. 6 shows an apparatus or system 600 incorporating sound (e.g., directional sound) technology and a dual display (e.g., see FIG. 4A) as part of a kiosk, stand, wall, and/or other apparatus or setup. The apparatus or system 600 may include features that are the same or similar to those previously discussed. For example, the apparatus or system 600 may include a display screen 605 (or more than one display screen, not illustrated) surrounded by a plurality of tiled material components, and a base for airflow or other heat management, the same as or similar to those previously discussed.

Multiple users may be permitted to interface with the display screen 605 (e.g., simultaneously and/or for example, in a real estate setting). The display screen 605 may be configured to display a software application's user interface for searching for real estate properties, wherein two users may simultaneously interface with a single display screen 605 via two portions of the single display screen 605—on a left area 612 and a right area 610 of the display screen 605.

In one embodiment, as illustrated, a first directional sound element or speaker 622 (e.g., configured for a user interacting in the left area 612 of the display screen 605) may be positioned and/or mounted above the display screen 605. In an alternative embodiment, this first directional sound element 622 may be alternatively positioned (e.g., in the floor or adjacent to the display screen 605, such as behind or adjacent with one or more of the tiled components). Likewise, as illustrated, a second directional sound element or speaker 620 (e.g., configured for a user interacting in the right area 610 of the display screen 605) may be positioned and/or mounted above the display screen 605. In an alternative embodiment, this second directional sound element 620 may be alternatively positioned (e.g., in the floor or adjacent to the display screen 605, such as behind or adjacent with one or more of the tiled components). For example, one or more of the directional sound elements (622, 620) may be disposed in a base (e.g., base 426 of FIG. 4A) and directed upwards. Indeed, a base for any embodiment may be used for additional or alternative functionality than mere heat management (e.g., stability, mounting capabilities, etc.)

In operation, a user interfacing with the left side 612 of the display screen 605 would hear the sound emitting from the first directional sound element 622 due to the user's location and/or the positioning and/or orientation of the first directional sound element 622. Similarly, the user interfacing with the left side 612 of the display screen 605 would not hear sound emitting from the second directional sound element 620 and vice versa for a user interfacing with the right side 610 of the display screen 605. For example, if sound corresponding to the display screen 605 from a computer system is established in a stereo format, the sound corresponding to the left channel of this stereo format may be provided to the first directional sound element 622 while sound corresponding to the right channel of the stereo format may be provided to the second directional sound element 620. In this fashion, users may have a sense of privacy established and/or will not be distracted, confused, or interrupted by sound that is playing in response or for other users interacting with different areas of the display screen 605. Similar operation or setup may be used for multi-monitor or display setups (e.g., a user operating on one display may only hear audio directed and/or intended for that one display and reduced ability to hear audio that is intended to be directed and/or intended for other displays). In certain embodiments, common sound components (e.g., speakers) may be provided that play sound that all users can hear and/or additional directional sound elements are provided for other users intended to be located in other locations.

FIG. 7 shows a block diagram 700 of an apparatus or system incorporating multiple display and sound technology as part of a kiosk, stand, wall, or other desired apparatus. The apparatus or system may include features that are the same or similar to those previously discussed. For example, the apparatus or system may include one or more display screens surrounded by a plurality of tiled (or non-tiled) material components and a base (e.g., for airflow, heat management, or other intended functionality), the same as or similar to those previously discussed. FIG. 7 illustrates an exemplary embodiment including a first monitor 702 that is connected 781 (e.g., via a hardwire, such as video cable(s)) to a first computer 704 or other system capable of sending display signals to the first monitor 702. The first computer 704 is likewise connected 782 to a first speaker or audio device 706 (e.g., one or more directional speakers).

Similarly, the block diagram 700 also illustrates a second monitor 752 that is connected 791 (e.g., via a hardwire, such as video cable(s)) to a second computer 754 or other system capable of sending display signals to the second monitor 752. The second computer 754 is likewise connected 792 to a second speaker or audio device 756 (e.g., one or more directional speakers). The same as or similar to previous discussions, a software application may run on the first computer 704 and/or the second computer 754 in order to display appropriate images on the first monitor 702 and/or second monitor 752 and/or to receive user input (e.g., via touchscreen responses). In one embodiment, if the first monitor 702 and/or second monitor 752 are intended to have an image (e.g., a photograph, image, video, etc.) move or transition from one to another, the first computer 704 and the second computer 754 may also be connected 795 and/or in communication with each other in order to appropriately synchronize the image (e.g., so that it does not appear to “jump” or improperly change position when transitioning).

Such syncing (e.g., to prevent lag and delay over time and/or when multiple display screens are in use and the video transitions from one screen to another) may be performed via Internet-based time servers to help ensure each computer's clock is accurate and consistent across the physical systems. With this “common” time working on each computer, an offset may be calculated into each video and/or image desired to be synced based on a pre-shared starting time. This may allow the video to begin playing at the exact same time and/or spot on each computer regardless of when the computers were powered on. Such a system may also be configured to monitor synchronization over a period of time and re-adjust if desired. In another embodiment, a single computer may be used such that syncing of videos or images between two different computers is not needed or such that any syncing calculations may be more easily performed (e.g., via a single CPU).

In still another embodiment, if video is intended to be running (e.g., high definition video if one or more of the first monitor 702 and/or second monitor 752 are higher resolution monitors, such as 4K resolution, the first computer 704 and/or second computer 754 may be configured to run on a separate thread of an executing software application. For example, performance issues with high resolution video data (e.g., 4K resolution) and user interfaces running simultaneously may be addressed via separating video versus other elements of the software application into two pieces or code streams which can be run independently on different threads to provide maximum performance to each piece or code.

In one embodiment, the video playback may be setup as a custom view (e.g., using Apple AV Framework) and any additional web technologies layer may use a second view (e.g., incorporating Apple WebKit Framework). This may allow layering of the web view on top of the video view and can help keep the video playback in the background. In certain embodiments, the web view may always be layered on top of the vide view. This background video stream may show through the web layer (e.g., a fully or partially transparent background set for the web layer). Such functionality and/or setup may provide for less risk of video “hitching” performance. If the video is to be located behind other user interface elements displayed on one or more of the first monitor 702 and/or second monitor 752, a user interface may be layered on top (e.g., may allow for some transparency).

The previously discussed system and/or features of a software application running thereon may include features and/or operation different from those stated in the exemplary embodiments detailed above. Features and/or operation in one embodiment may also or additionally be included with features and/or operation of a separately discussed embodiment. Moreover, features may be added, removed, or executed/implemented with different operative flow from the exemplary embodiments detailed above. For example, greater or fewer display screens for accommodating one or multiple simultaneous users of a software application being displayed thereon may be established in various embodiments.

In certain embodiments, a kiosk, stand, wall, or other apparatus with certain features as described may be configured to display a software application (e.g., one created using web-based technologies such as written in PHP, HTML, CSS, JavaScript and/or jQuery) and may be configured to run any of a variety of players (e.g., Macintosh OS X Player written in Objective-C using Xcode). For example, a kiosk, stand, wall, or other apparatus may feature full-time looping 4k Ultra High Definition (UHD) video playing alongside or behind user-interface elements (e.g., video playing both while idle and when actively engaged by a user). In certain embodiments, the video may stay “behind” the user interface elements and/or other template elements of the displayed software application (e.g., with a transparency effect allowing the video to be seen through the user interface).

Further, in certain embodiments, mapping software or applications (e.g., Google Maps or other services, such as remote services) may be setup to interface and/or be displayed on one or more displays of the apparatus or system. For example, since some remote services (e.g., Google Maps) may have performance and/or reliability issues that can affect the apparatus or system due to storage of its libraries and/or assets in a cloud environment or other network system, improper initialization may occur if one or more of such assets do not load prior to apparatus or system startup and can result in appropriate response to user input (e.g., touch actions). Additional coding steps or controls to ensure appropriate initialization (e.g., either due to local variable initialization and/or control checks on remote services) may be implemented to help avoid user input issues.

In addition, in certain embodiments as previously discussed, multiple users may be permitted upon a single instance or software application (e.g., two or more users may interface upon a single display, such as on a left and right side, such display being powered by a single system or software application. For example, this may be accomplished by architecting the software application to be unaware of which area of the screen it would be operating, thus allowing for a single codebase and deploy to upon multiple areas on the same screen. For example, a single loader application can bisect the display screen into two (or more) areas (e.g., equal areas down the center of the display). In one example, an identical copy of the application is imported into each area and then a loader initializes each copy which starts its run cycle. When starting up, each copy of the application may be designated the name of the area it is contained in (e.g., its parent—left or right) and then may use that reference to maintain its identity throughout its run cycle so that actions and states inside one specific container (e.g., the left container) may be completely independent from another container (e.g., the right container). This may allow for searching for objects that are children of its respective container and allows each “side” of the application to co-exist and share common code.

Moreover, in certain embodiments, stands, kiosks, walls, or other hardware setups with one or more features that are the same as or similar to those previously discussed may be configured to be customizable and/or mobile in nature. For example, it may be desirable to setup a particular kiosk for only a temporary amount of time. In such situations, the hardware setup may be configured to be easily assembled and/or disassembled in order to save time and/or costs. In one embodiment, one or more components may be configured to snap, lock, or otherwise engage with one or more other components, for example, in a modular fashion (e.g., a kiosk or other hardware setup may be created having any desired number of monitors or displays, such displays modularly connecting with components as desired to create a particular kiosk. Thus, a particular component may have a connectable edge or other portion that is configured to engage with connectable edges of multiple different components such that a variety of such multiple different components may be chosen to engage therewith. In this fashion, customized kiosks and/or mobile kiosks may be created through a minimal amount of assembly/disassembly time. Costs associated with transportation or marketing of parts may additionally be lowered due to a reduced number of tools and/or manufacturing costs that may otherwise be required if differing components had connectible edges and/or other portions that were only allowed to engage with a more restrictive subset of hardware components.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

What is claimed is:

1. An apparatus for providing visual stimulation to a user comprising:
a first display screen configured to receive first input;
at least one lighting cell configured to illuminate through at least one or the plurality of tiled materials based upon interaction by the user;
a plurality of tiled materials disposed adjacent to the first display screen; and
a base disposed long an edge of at least one of the plurality of tiled materials configured to dissipate heat from an area adjacent to the first display screen to a second area.

2. The apparatus of claim 1 wherein the base includes a plurality of holes therein for dissipation of heat.

3. The apparatus of claim 2 further comprising at least one fan configured to flow air through at least one of the plurality of holes in the base.

4. The apparatus of claim 1 further comprising an audible device configured to provide sound to the user based upon the first input.

5. The apparatus of claim 4 wherein the audible device is a directional speaker.

6. The apparatus of claim 5 further comprising a first processor connected with the first display screen and the audible device, the first processor configured to determine data to be displayed on the first display screen and sound to be provided to the user from the audible device based upon the first input received via the first display screen.

7. The apparatus of claim 1 further comprising a first processor connected with the first display screen, the first processor configured to determine data to be displayed on the first display screen based upon the first input received via the first display screen.

8. An apparatus for providing visual stimulation to a user comprising:
a first display screen configured to receive first input;
a second display screen positioned adjacent to the first display screen and configured to receive second input;
a first processor connected with the first display screen;
a second processor connected with the second display screen;
a memory connected with the first processor; and
a plurality of tiled materials disposed adjacent to the first display screen and the second display screen,
wherein the first processor is configured to determine data to be displayed on the first display screen based upon the first input received via the first display screen and wherein the second processor is configured to determine second data to be displayed on the second display screen based upon the second input received via the second display screen.

9. The apparatus of claim 8 wherein the first input and the second input may be received simultaneously.

10. The apparatus of claim 9 wherein the first display screen is configured to receive third input and wherein the first input and the third input may be received simultaneously.

11. The apparatus of claim 8 further comprising a first sound element connected with the first processor and configured to emit sound based upon operation of the first processor.

12. The apparatus of claim 11 further comprising a second sound element connected with the first processor and configured to emit a second sound based upon operation of the first processor.

13. The apparatus of claim 12 wherein a user is configured to hear only one of the first sound or the second sound simultaneously.

14. The apparatus of claim 13 wherein the first sound element or the second sound element are directional sound speakers.

15. A method for receiving and responding to user input comprising:
providing a first display configured to receive a first input;
providing a second display configured to receive a second input;
providing a first directional audio component configured to emit sound corresponding to the first display;
providing a second directional audio component configured to emit sound corresponding to the second display;
determining first visual data to be displayed on the first display based upon the first input received via the first display;
determining second visual data to be displayed on the second display based upon the second input received via the second display;
determining first audible data to be emitted by the first directional audio component;
determining second audible data to be emitted by the second directional audio component; and
communicating the first visual data to the first display, the second visual data to the second display, the first audible data to the first directional audio component, and the second audible data to the second directional audio component.

16. The method of claim 15 further comprising receiving the first input and the second input simultaneously.

17. The method of claim 15 wherein the first display or the second display has a display resolution of at least 1920×1080 pixels.

18. The method of claim 17 wherein the first display or the second display has a display resolution of at least 3840×2160 pixels.

19. The method of claim 15 further comprising providing at least one lighting cell adjacent to the first display or the second display, the at least one lighting cell configured to illuminate based upon user interaction.

20. The method of claim 15 further comprising an at least partially transparent material disposed adjacent to the first display or the second display, the at least one lighting cell configured to illuminate through the at least partially transparent material.
